(19) United States
(12) Patent Application Publication
(10) Pub. No.: US 2007/0287184 A1
(43) Pub. Date: Dec. 13, 2007

(54) Method Of Determining Pore Characteristic, Preparation Method Of Sample Unit, And Sample Unit

(76) Inventors: Ville-Veikko Telkki, Oulu (FI); Juhani Lounila, Oulu (FI); Jukka Jokisaari, Oulu (FI)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/665,132

(22) PCT Filed: Oct. 11, 2005
(86) PCT No.: PCT/FI05/50353

§ 371 Date: Jul. 17, 2007

(30) Foreign Application Priority Data
Oct. 12, 2004 (FI) 20045381

(51) Int. Cl. G01N 24/00; G01N 23/00

(52) U.S. Cl. 436/57; 436/173

(57) ABSTRACT

A method of determining a pore characteristic, a method of preparing a sample unit, and a sample unit are provided. In the method of determining, a sample is subjected to an external magnetic field, the sample including a porous substance and a medium including a confined portion confined into the pores of the porous substance and a bulk portion surrounding at least a portion of the porous substance, the sample further including probe gas soluble to the medium and inert to the medium and to the porous substance and having a nuclear magnetic response to electromagnetic stimulation, the nuclear magnetic response depending on the magnetic environment of the probe gas, at least a portion of the probe gas being confined to the pores and being transferred into the pores as dissolved in the confined portion, the medium being selected to generate a magnetic environment for the probe gas confined to the pores that differs from the magnetic environment of the probe gas dissolved in the bulk portion; electromagnetic stimulation is applied to the sample, the electromagnetic stimulation being selected to induce at least one response signal in the probe gas; the at least one response signal is recorded; and the pore characteristic is determined from the at least one response signal.

### FIELD

The invention relates to a method of determining a pore characteristic of a porous substance, a preparation method of preparing a sample for the determination of a pore characteristic of a porous substance with nuclear magnetic resonance spectroscopy, and a sample unit for determining a pore characteristic of a porous substance with nuclear magnetic resonance spectroscopy.

### BACKGROUND

Porous materials are typically solids with a large internal surface primarily due to the walls of interconnecting networks of pores and cavities. The primary physical properties of porous materials are defined by pore characteristics, such as pore size, pore size distribution and pore volume.

Prior art suggests various techniques, such as gas adsorption NMR (Nuclear Magnetic Resonance) cryoporometry, mercury porosiometry, and NMR relaxometry, for determining pore characteristics. However, the prior art techniques are either inaccurate and/or require a complex and time-consuming measurement procedure. Therefore, there is a need to consider alternatives for determining pore characteristics of porous materials.

### BRIEF DESCRIPTION OF THE INVENTION

An object of the invention is to provide an improved method of determining a pore characteristic of a porous substance, an improved preparation method of preparing a sample for the determination of a pore characteristic of a porous substance with nuclear magnetic resonance spectroscopy, and an improved sample unit for determining a pore characteristic of a porous substance with nuclear magnetic resonance spectroscopy. According to a first aspect of the invention, there is provided a method of determining a pore characteristic of a porous substance, including: subjecting a sample to an external magnetic field, the sample including the porous substance and a medium with a confined portion confined into the pores of the porous substance and a bulk portion surrounding at least a portion of the porous substance, the sample further including probe gas soluble to the medium and inert to the medium and to the porous substance and having a nuclear magnetic response to electromagnetic stimulation, the nuclear magnetic response depending on the magnetic environment of the probe gas, at least a portion of the probe gas being confined to the pores and being transferred into the pores as dissolved in the confined portion, the medium being selected to generate a magnetic environment for the probe gas confined to the pores that differs from the magnetic environment of the probe gas dissolved in the bulk portion; applying electromagnetic stimulation to the sample, the electromagnetic stimulation being selected to induce at least one response signal in the probe gas; recording the at least one response signal; and determining the pore characteristic from the at least one response signal.

According to a second aspect of the invention, there is provided a preparation method of preparing a sample for the determination of a pore characteristic of a porous substance with nuclear magnetic resonance spectroscopy, including: placing the porous substance into an air-tight container; inserting liquid-phase medium into the air-tight container, thus producing a confined portion and a bulk portion of the medium, the confined portion being confined into the pores of the porous substance and the bulk portion surrounding at least a portion of the porous substance, the medium being selected to generate a magnetic environment for the probe gas confined to the pores that differs from the magnetic environment of the probe gas dissolved in the bulk portion; and dissolving a quantity of the probe gas into the medium, the probe gas being inert to the medium and to the porous substance and having a nuclear magnetic response to electromagnetic stimulation, the nuclear magnetic response depending on the magnetic environment of the probe gas, thus transferring at least a portion of the probe gas into the pores as dissolved in the confined portion.

According to another aspect of the invention, there is provided a sample unit for determining a pore characteristic of a porous substance with nuclear magnetic resonance spectroscopy, including: a porous substance; a medium including a confined portion confined into the pores of the porous substance and a bulk portion surrounding at least a portion of the porous substance; probe gas soluble to the medium and inert to the medium and to the porous substance and having a nuclear magnetic response to electromagnetic stimulation, the nuclear magnetic response depending on the magnetic environment of the probe gas, at least a portion of the probe gas being confined to the pores and being transferred into the pores as dissolved in the confined portion; and the medium being selected to generate a magnetic environment for the probe gas confined to the pores that differs from the magnetic environment of the probe gas dissolved in the bulk portion.

The invention provides several advantages. The invention enables the determination of a pore characteristic, such as pore size, pore size distribution, and/or pore volume, with a single NMR measurement carried out at one sample temperature, thus reducing the need to carry out a series of NMR measurements at different thermal conditions. The use of the medium increases the sensitivity of the probe gas to the pore characteristic resulting in accurate determination of the pore characteristic.

### LIST OF DRAWINGS

In the following, the invention will be described in greater detail with reference to embodiments of the invention and the accompanying drawings, in which

FIG. 1 shows an example of the structure of an NMR apparatus;

FIG. 2A illustrates an example of a sample unit;

FIG. 2B illustrates an example of a part of the sample unit;

FIG. 3 shows the phase behaviour of a medium;

FIG. 4A shows an example of a part of the sample at a first sampie temperature;

FIG. 4B shows an example of a part of the sample at a second sample temperature;

FIG. 4C shows an example of a part of the sample at a third sample temperature;

FIG. 5 shows examples of NMR spectra at different sample temperatures;

FIG. 6 shows an example of a reference curve;

FIG. 7 shows an example of a methodology of preparing a sample unit according to the embodiments of the invention; and

FIG. 8 shows an example of a methodology of determining a pore characteristic according to the embodiments of the invention.

### DESCRIPTION OF EMBODIMENTS

With reference to FIG. 1, an example of an NMR (Nuclear Magnetic Resonance) apparatus 100 for NMR measurements is shown. The NMR apparatus 100 includes magnetizing units (M1, M2) 102, 104 and a sample unit 106 placed typically inside the magnetizing units 102, 104. The magnetizing units 102, 104 generate an external magnetic field 128 applied to the sample unit 106, thus inducing a macroscopic magnetization of the NMR active nuclei of substances placed in the sample unit 106. In some applications, the magnetizing units 102, 104 may consist of a single super-conducting coil.

The NMR apparatus 100 further comprises stimulation means 108, 118 for providing an electromagnetic stimulation for the sample unit 106. The stimulation means typically include a signal generator (SG) 108 and an induction coil 118 placed in the vicinity of the sample unit 106. The signal generator 108 generates an electric signal 120 including radio frequencies that correspond to the energy differences between spin states of the NMR active spins of the substances placed in the external magnetic field 128. The induction coil 118 transforms the electric signal 120 into an electromagnetic field oscillating at the radio frequencies, thus resulting in an excitation of the NMR active spins in the sample unit 106 from lower energy levels to upper energy levels.

The NMR apparatus 100 further comprises detection means 110, 116 for detecting the response of the NMR active nuclei of the substance placed in the sample unit 106 to the electromagnetic stimulation provided by the stimulation means 108, 118. The electromagnetic stimulation is also referred to as magnetic stimulation, since it is the magnetic component of the electromagnetic field that plays the primary role in the stimulation. The detection means 110, 116 typically include a detection coil 116 placed in the vicinity of the sample unit 106. The detection coil 116 detects the internal magnetic field generated by the NMR active nuclei of the substance placed in the sampie unit 106 after the electromagnetic stimulation. The detection coil 116 transforms the internal magnetic field into a response signal 122 that characterizes the spin energy levels of the NMR active nuclei of the substances placed in the sample unit 106. The detection coil 116 may be connected to a detector unit 110 (DU) which processes the response signal 122, for example, by amplifying, filtering, and/or carrying out analogue-to-digital conversions. The response signal 122 is also referred to as an NMR signal or an FID (Free Induction Decay). A plurality of NMR signals shown in a same scale is referred to as an NMR spectrum. The NMR spectrum may be formed by combining different frequency components of the NMR signal measured at different time instants or by obtaining the different frequency components of the NMR signal in a single measurement or in a series of successive measurements.

In some embodiments, it is customary to present the response signal 122 in the frequency domain. In such a case, the response signal 122 is presented in a chemical shift scale that characterizes the frequency content of the response signal 122 in relation to a known reference, such as tetramethyl silane (TMS).

In some embodiments, the induction coil 118 and the detection coil 116 are integrated into a single coil structure. In such a case, a switch arrangement is applied to separate the stimulation means 108, 118 from the detection means 110, 116.

The NMR apparatus 100 may further include a recording unit (RU) 112 for recording a digital response signal 124 into a mass memory for later use.

The NMR apparatus 100 may further include a processing unit 114 connected to the recording unit 112. The processing unit 114 may perform tasks, such as a Fourier transformation of the digital response signal 126, summation of a plurality of digital response signals 126, and generation of control signals 130 that control the signal generator 108.

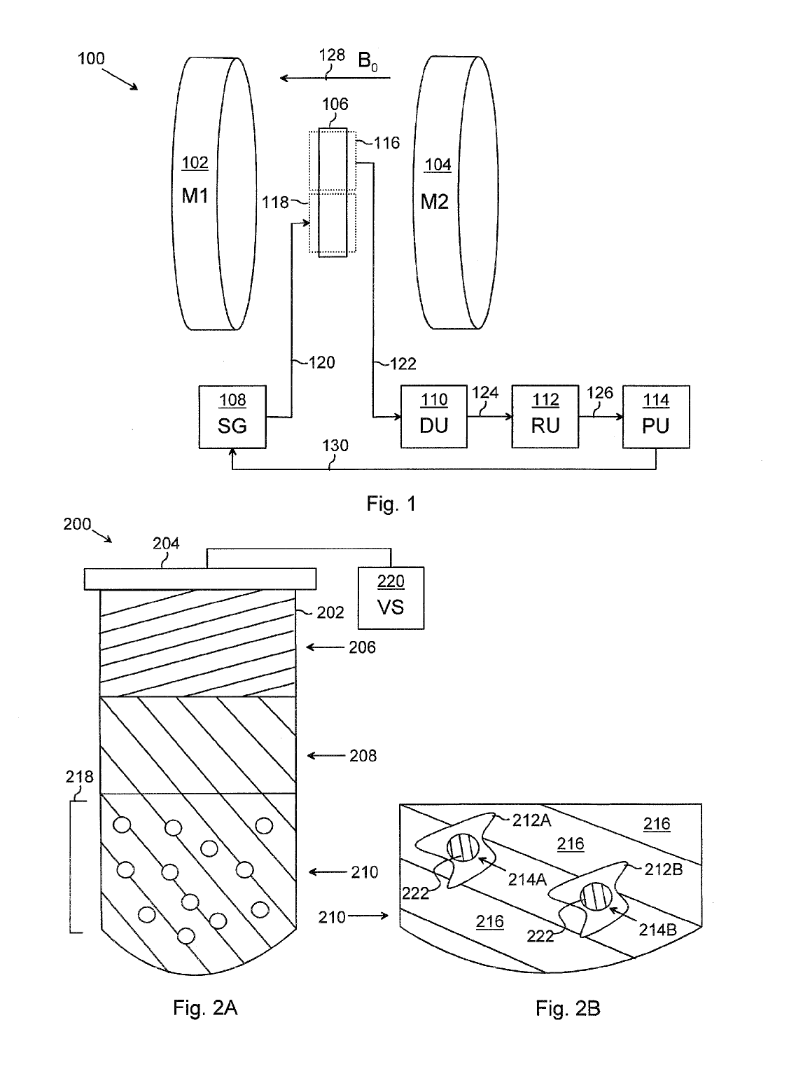

With reference to FIG. 2A, the sample unit 200 includes an air-tight container 202, such as a glass tube, suitable for depressurization and placement into a sample compartment of the NMR apparatus 100. In a sample preparation stage, a porous substance is put into the container 200. Furthermore, impurities, such as residual water, are removed from the sample unit 200 by depressurizing the container 202 with a vacuum system 220 connected to the container 202. The container 202 may be isolated from the vacuum system 220 after the sample preparation with an air-tight cap 204 or by melting a part of the container 200 in order to sealing the neck of the container 200.

The structure and operation of the vacuum system 220 and the methods of transferring gaseous substances in the vacuum system 220 into the container 200 and isolating the container 200 from atmospheric pressure after sample preparation are known to a person skilled in NMR sample preparation. Therefore, only details relevant to the present solution are discussed in this context.

The sample unit 200 further includes a liquid-phase medium inserted into the container 202. The medium is typically introduced into the container 202 such that the surface of the medium remains on the top of the coil region 218 of the NMR apparatus 100. The medium provides a bath for the porous substance and penetrates into the pores of the porous substance. As a result, a portion of the medium is confined to the pores. The portion of the medium confined to the pores is also referred to as the confined medium.

The porous substance is typically a powder-like material in order to improve access to the pores and to ease the penetration of the medium into the pores. The particle size of a porous substance powder may fall into micrometer region. In some embodiments, the diameter of the particles varies from 10 to 200 μm. The particle size is not, however, restricted to the given figures.

A portion of the medium surrounds the porous substance. The portion of the medium surrounding the porous substance and excluding the confined medium is also referred to as the bulk medium.

The mixture of the porous substance and the medium typically form a measurement layer 210 of the sample. The height of the measurement layer 210 is typically in the centimetre range, varying from 1 to 3 cm, for example. The height of the measurement layer 210 is not, however, restricted to the given figures, but depends on external factors, such as the coil structure of the NMR apparatus 100.

The excess medium 208 above the measurement layer 210 forms a medium layer 208. The measurement layer 210 is primarily subjected to NMR measurement when determining a pore characteristic of the porous substance.

FIG. 2B shows an example of the structure of the measurement layer 210. The porous substance is presented by particles 212A, 212B having pores 214A, 214B that confine the confined medium 222. The bulk medium 216 surrounds the particles 212A, 212B.

In the preparation of the sample unit 200, a quantity of probe gas is dissolved into the medium by introducing pressurized probe gas into the sample unit 200. The vacuum system 220 may have a suitable valve arrangement and a manometer in order to control the flow to the container 202 and the quantity of the pressurized probe gas in the container 202. The pressure applied to the probe gas in the ambient temperature may vary from 1 to 4 atmospheres. The present solution is not, however, restricted to these pressure values but the value may be chosen according to probe gas characteristics and medium characteristics.

In an embodiment of the invention, the quantity of the probe gas introduced into the container 202 is recorded in order to scale the results obtained from the NMR measurement with a known reference. The known reference may be a sample unit similar to the sample unit 202 applied in an actual determination and including a porous substance with known pore characteristics.

The introduction of the probe gas into the container 202 is typically preceded by the cooling of the sample unit 200 to a low temperature with, for example, liquid nitrogen. In this case, the quantity of the probe gas introduced into the container 202 may be calculated from the volume of the container 202, the pressure of the probe gas buffered into the feeding line of the vacuum system 220, and the volume of the feeding line of the vacuum system 220.

The excess probe gas typically forms a probe gas layer 206 in the sample unit 200. A portion of the probe gas is transferred into the pores 214A, 214B as dissolved in the confined medium 222. A portion of the probe gas is dissolved in the bulk medium 216.

The probe gas is typically inert to the medium and to the porous substance in order to leave the sample chemically stable during the sample preparation and the determination of the pore characteristic. Furthermore, the probe gas has a nuclear magnetic response to electromagnetic stimulation, which magnetic response depends on the magnetic environment of the probe gas. The nuclear magnetic response may be observed from the response signal 122 generated in the sample unit 106 as a result of the electromagnetic stimulation generated by the stimulation means 108, 118.

In an embodiment of the invention, the probe gas includes atoms/molecules with non-zero nuclear spin s, such as s=½. Furthermore, the probe gas may be selected to have a large gyromagnetic ratio.

In an embodiment of the invention, the probe gas includes NMR active noble gas, such as ¹²⁹xenon having s=½ and a natural abundance of 26.4%. Furthermore, xenon has a spherical and an easily polarizable electron structure, thus being sensitive to the magnetic environment.

The magnetic environment typically includes an intrinsic magnetic environment arising from intra-atomic/intramolecular mechanisms, and an external magnetic environment generated by the surroundings of the probe gas atoms/molecules. The external magnetic environment may be caused by the medium in which the probe gas is dissolved and possibly by the free space surrounding the probe gas atoms/molecules.

The medium is selected so that a magnetic environment is generated for the probe gas confined to the pores 214A, 214B that differs from the magnetic environment of the probe gas dissolved in the bulk medium 216. The different magnetic environments in the pores 214A, 214B and in the bulk medium 216 result in frequency characteristics of the response signal 122 being generated in the pores 214A, 214B that differs from frequency characteristics being generated in the bulk medium 216. The difference in the magnetic environment in the pores 214A, 214B and in the bulk medium 216, respectively, arises from a physical influence of the pore cavity to the medium. The bulk medium 216 experiences virtually an unaffected environment in the molecular scale while the pores 214A, 214B affect the physical characteristics of the confined medium 222 such that the probe gas confined to the pores 214A, 214B experiences an influenced magnetic environment.

The influence of the pores 214A, 214B on the confined medium 222 depends on a pore characteristic, such as the size, of the pore 214A, 214B, and consequently, the response signal 122 generated in the probe gas confined to the pore 214A, 214B carries information of the pore characteristic in the frequency content of the response signal 122. In a practical NMR measurement, a porous substance includes a plurality of pores 214A, 214B with different pore characteristics, and the response signal 122 is contributed by a spectrum element characterizing each pore 214A, 214B. Thereby, the response signal 122 includes a frequency distribution that characterizes the pore characteristic distribution of the sample.

Whether the pore size of the pores 214A, 214B is detectable from the response signal 122, depends typically on the resolution of the NMR apparatus 100, physical relation between the medium and the porous material, and the physical relation between the medium and the probe gas.

In an embodiment of the invention, the medium is condensed fluid, such as liquid, the medium being selected to provide a magnetic environment for the probe gas dissolved in the confined medium 222 that differs from the magnetic environment for the probe gas dissolved in the bulk medium 216. As a result, a response signal 122 is generated in the probe gas dissolved in the confined medium 222 that differs from a response signal 122 generated in the bulk medium 216 when the electromagnetic stimulation is applied to the sampie. In this case, the confined medium 222 and the bulk medium 216 are a liquid-state material or liquid crystal. The pore 214A, 214B affects the confined medium 222 through interaction mechanisms, such as a surface tension mechanism, such that the probe gas dissolved in the confined medium 222 experiences a magnetic environment characteristic to the pore 214A, 214B. When electromagnetic stimulation is applied to the sample, a response signal characteristic to the pore 214A, 214B is generated.

The medium may be acetonitrile or naphthalene, for example. The invention is not, however, restricted to acetonitrile and naphthalene, but any chemical substance filling the physical and chemical requirements of the medium may be used. Such requirements are, for example, low chemical reactivity with the porous material and a feasible solidification temperature, such as that close to the ambient temperature.

In an embodiment of the invention, the medium is a liquid crystal and selected to have an isotropic phase in the confined medium 222 and an anisotropic phase in the bulk medium 216 at a measurement temperature.

The liquid crystal is a thermotropic liquid crystal, for example. In an embodiment of the invention, the medium is selected to have a lower phase-transition temperature in the confined medium 222 than the phase-transition temperature in the bulk medium 216. The phase transition occurs between the liquid phase and the solid phase. In this embodiment, the medium is further selected to have a larger density in the solid phase than the density in the liquid phase.

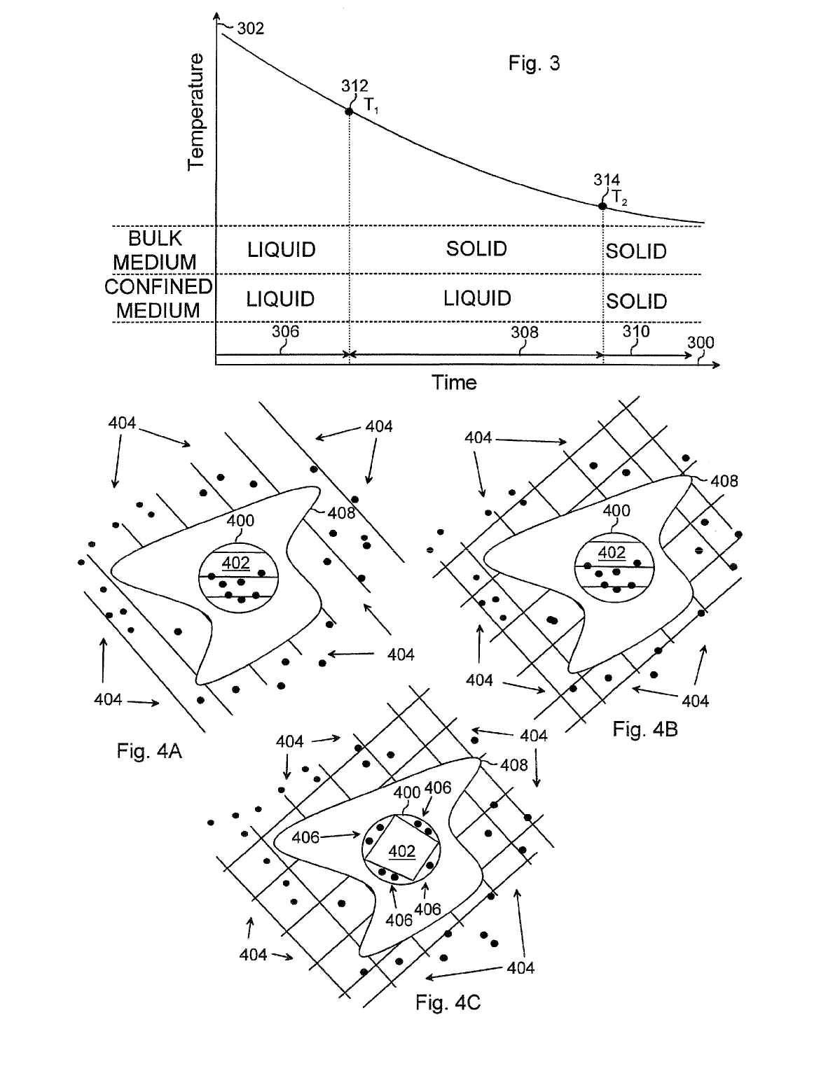

With reference to FIG. 3, the phase behaviour of the medium is shown as a function of a sample temperature. The horizontal axis 300 represents time in arbitrary units, such as hours, while the vertical axis 302 shows the sample temperature in arbitrary units, such as Kelvin.

During a first time period 306, both the bulk medium 216 and the confined medium 222 are in the liquid state. When the sample temperature is decreased to a first phase-transition temperature 312 T₁, the phase transition of the bulk medium 216 from the liquid state to the solid state takes place, while the confined medium 222 remains in the liquid phase.

During a second time period 308, the sample temperature is further decreased from the first phase-transition temperature 312 T₁ to a second phase-transition temperature 314 T₂. During the second time period 308, the bulk medium 216 remains solid and the confined medium 222 remains liquid. At the second phase-transition temperature 314 T₂, a phase transition in the confined medium 222 takes place from the liquid state to the solid state. During a third time period 310, both the bulk medium 216 and the confined medium 222 appear in the solid state.

In mathematical terms, the difference ΔT_{D} in the phase-transition temperatures between the solid phase and the liquid phase in the bulk medium 216 and in the confined medium 222 may be expressed with the GibbsThompson equation

$$Δ {T}_{D} = {T}_{B} - {T}_{C} = \frac{{k}_{p}}{{R}_{p}} \qquad ( 1 )$$

where T_{B} and T_{C} are the phase-transition temperatures of the bulk medium 216 and confined medium 222, respectively, kₚ is a constant characterizing the medium, and Rₚ is a pore radius of a pore 214A, 214B.

It should be noted that the strict limits between the solid state and the liquid state are introduced for the ease of illustration. In real porous systems, the pore characteristics may vary between the pores 214A, 214B, and the first phase-transition temperature 312 T₁ and the second phase-transition temperature 314 T₂ should be understood as average temperatures or other temperature measures that characterize the temperature behaviour of the medium in a plurality of pores 214A, 214B.

With reference to FIGS. 4A, 4B, and 4C, let us consider the phase transitions shown in FIG. 3 on a pore level.

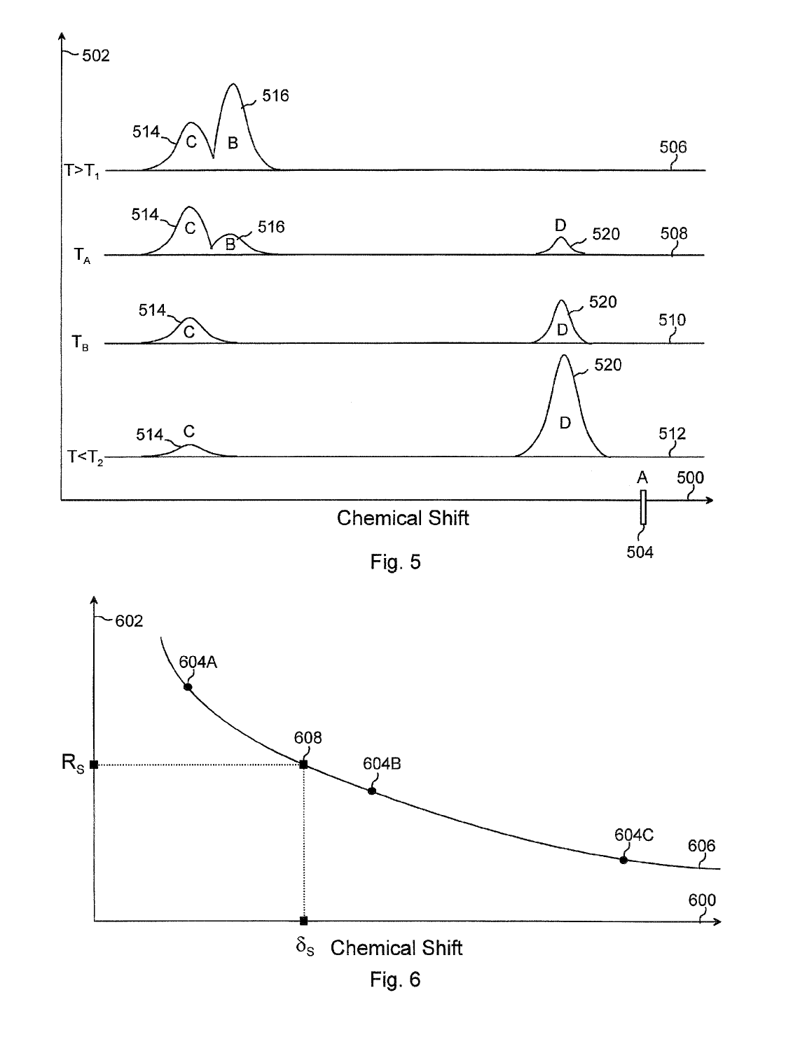

FIG. 5 shows an example of NMR spectra 506 to 512 of the sample during sample temperature evolution from the first phase-transition temperature 312 T₁ to the second phase-transition temperature 314 T₂ shown in FIG. 3. The horizontal axis 500 shows a chemical shift in arbitrary units, such as ppm (parts per million), while the vertical axis 502 shows the spectrum intensity in arbitrary units, such as power units. The reference point 504 corresponding to a zero chemical shift is labelled with a vertical bar and the value of the chemical shift increases to the left from the reference point 504.

The NMR spectra 506 to 512 may be obtained by applying the electromagnetic stimulation including radio frequencies corresponding to the chemical shifts expected to appear in the spectra 506 to 512. In an embodiment, an appropriate frequency content of the electromagnetic stimulation is achieved by subjecting the sample unit 106 to a short electromagnetic pulse generated by the stimulation means 108, 118. In this case, the required spectrum range is measured at once. The quality of the spectrum 506 to 512 may be improved by repeating the pulse and by co-adding the spectrum components.

The response signal 122 is detected by the detecting means 110, 116 and the digital response signal 124 is taken to the recording unit 112. The recording unit 112 may store the spectrum components and co-add the spectrum components in order to generate a sum spectrum 506 to 512.

FIG. 4A illustrates the bulk medium 404 surrounding a particle 408 of the porous substance and the confined medium 402 confined in a pore 400 of the particle 408 during the first time period 306. At this stage, the bulk medium 404 and the confined medium 402 are in the liquid state, and the probe gas dissolved in the medium may freely access the pore 400 by normal physical mechanisms, such as those driven by thermal effects. The probe gas dissolved in the medium is represented by black dots.

The first NMR spectrum 506 in FIG. 5 represents an example of an NMR spectrum recorded during the first time period 306. The first NMR spectrum 506 may include a first signal (C) 514 and a second signal (B) 516 originating from probe gas dissolved in the liquid-state medium. The first signal 514 originates from the probe gas dissolved in the confined medium 402 that is in the liquid state. The second signal 516 originates from the probe gas dissolved in the bulk medium 404 that is in the liquid state.

The first signal 514 and the second signal 516 provide pore characteristics, such as an average pore size and a pore size distribution. The average pore size may be obtained from the center-of-mass of the first signal 514 while the pore size distribution may be obtained from the shape of the first signal 514. Furthermore, the first signal 514 provides a pore volume characterizing the integrated volume of the pores 214A, 214B in the sample. The pore volume may be obtained by taking an integral over the first signal 514.

In an embodiment of the invention, the pore radius Rₚ of a pore is obtained from formula

$${R}_{p} = a \cdot exp ( - \frac{\vert {δ}_{C} - {δ}_{B} \vert}{b} ) + c \cdot exp ( - \frac{\vert {δ}_{C} - {δ}_{B} \vert}{d} ) , \qquad ( 2 )$$

where δ_{b} and δₐ are the chemical shifts of the first signal 514 and second signal 516, respectively. Parameters a, b, c, and d are fitting parameters obtained for reference samples.

FIG. 4B illustrates the bulk medium 404 and the confined medium 402 during the second time interval 308. At this stage, the bulk medium 404 primarily is in the solid state providing a shield around the particle 408 and reducing the medium and the probe gas either entering or exiting the pore 400. The confined medium 402 primarily is in the liquid state.

A second and third NMR spectra 508 and 510 represent an example of NMR spectra recorded during the second time interval 308. The second NMR spectrum 508 is recorded at a higher temperature than the temperature applied to the third NMR spectrum 510.

In the second NMR spectrum, the second signal 516 has weakened as the phase transition from the liquid state to the solid state in the bulk medium 404 has started. The first signal 514 can still be identified as the confined medium 402 is primarily in the liquid state. However, at this stage, the solidification in the confined medium 402 confined to the largest pores has started, thus giving rise to an appearance of a third signal (D) 520.

In the third NMR spectrum 510, the second signal 516 does not occur due to the solidification of the bulk medium 404. The first signal 514 has weakened and the third signal 520 has gained strength.

FIG. 4C illustrates the bulk medium 404 and the confined medium 402 during the third time interval 310. The bulk medium 404 is in the solid state, thus reducing the exchange of the medium and the probe gas between the pore 400 and the surroundings of the particle 408. At this stage, the confined medium 402 is in the solid state, and due to the larger density in the solid state than in the liquid state, gas pockets 406 have been created as a result of shrinkage of the confined medium 402. For this reason, different magnetic environments have been created between the probe gas confined in the pore 400 and the probe gas dissolved in the bulk medium 404.

The fourth NMR spectrum 512 represents an example of an NMR spectrum recorded during the third time interval 310. At this stage, the first signal 514 is relatively weak and indicates a residual of a liquid-phase confined medium 402 in some of the pores 400. The third signal 520 has further gained strength due to the increased volume of the gas pockets 406.

In an embodiment of the invention, the probe gas and the medium are selected to have a higher solubility of the probe gas to the medium in the liquid state than the solubility of the probe gas to the medium in the solid state. The higher solubility in the liquid state increases the quantity of the probe gas being introduced in the gas pockets 406 when the confined medium 402 transforms from the liquid state to the solid state. The increase in the quantity of the probe gas in the gas pockets improves the sensitivity of the NMR measurement to the phase transition, thus improving the accuracy of the determination of the pore characteristic.

The perturbation due to the interaction of a probe gas atom with its surroundings in the gas pockets 406 lowers the magnetic shielding a of the probe nuclei. The smaller the gas pocket 406, the stronger the perturbation, and the higher the chemical shift of the third signal 520. As the size of the pocket 406 is proportional to the size of the pore 402, the chemical shift of the third signal 520 decreases with increasing pore size.

In an embodiment of the invention, the relation between the pore radius Rₚ and chemical shift δ of the third signal 520 is expressed as

$${R}_{p} = a \cdot exp ( - \frac{{δ}_{D}}{b} ) + c \cdot exp ( - \frac{{δ}_{D}}{d} ) , \qquad ( 3 )$$

where a, b, c and d are least-squares parameters that can be determined from reference samples.

FIG. 6 illustrates graphically Eq. (3). The horizontal axis 600 shows the chemical shift while the vertical axis 602 shows the pore radius. The least squares parameters a, b, c, and d and Eq. (3) define a reference curve 606 that may be obtained by determining the chemical shift 608 of the third signal 520 for a porous substance with known pore size characteristics. In this case, calibration points 604A, 604B, 604C have been determined and a least-squares fit has been carried out by using Eq. (3). The pore radius Rₛ of a sample with unknown pore characteristics may be obtained by determining the chemical shift δₛ of the third signal 520 and by using Eq. (3).

FIGS. 3, 4A, 4B, 4C, and 5 illustrate an example of a sample history. The sample is typically prepared within the temperature limits defined by the first time period 306 since both the bulk medium 404 and the confined medium 402 are in the liquid state. The direction of the time evolution is not, however, critical to the present solution, as long as the sample unit 106, 200 has experienced the first time period 306, i.e. a stage when both the bulk medium 404 and the confined medium 402 occur in the liquid state in order to enable the probe gas to access the pores 400. The actual measurement temperature at which the determination of the pore characteristics is carried out may be selected relatively freely. However, the measurement temperature may be fixed at a value depending on factors, such as the temperature of the reference measurement, characteristics of the medium, and pore characteristics to be determined.

In an embodiment of the invention, a plurality of NMR measurements are carried out at sample temperatures between the first sample temperature and the second sample temperature, thus producing a trend of response signals as a function of the sample temperature. The first sample temperature and the second sample temperature correspond to the first transition temperature 312 and the second transition temperature 314, respectively. The NMR measurements result in NMR spectra similar to NMR spectra 506 to 512. The trend of the response signals may be monitored by determining the strength of the NMR signals 514, 516, 520.

In an embodiment of the invention, the trend of the third signal 520 is recorded and the solidification temperature of the confined medium 402 is determined from the trend. In the solidification temperature, the third signal 520 vanishes. The pore radius Rₚ may then be obtained from Eq. (1) where the solidification temperature of the bulk medium 404 may be taken from literature or from the trend of the second signal 516.

In an embodiment of the invention, the sample temperature is increased between successive measurements in order to avoid supercooling effects of the sample. After each measurement, the sample may be allowed to stabilize.

The sample temperature may be monitored by measuring directly the sample temperature in the sample unit 106, 200. In an embodiment, the sample unit 106, 200 includes a capillary tube including an NMR active chemical giving an NMR signal which is sensitive to temperature. The actual temperature may be determined from the chemical shift of the signal generated from the chemical and from a calibration curve.

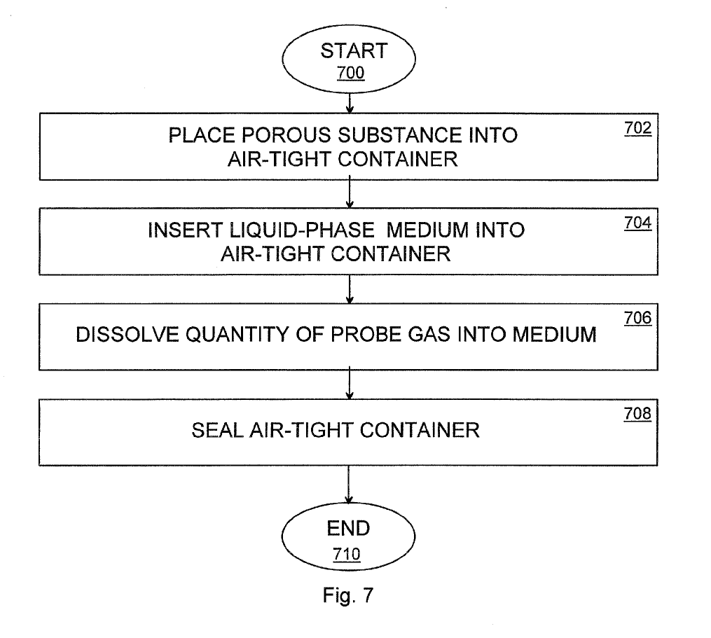

With reference to FIG. 7, embodiments of the method of preparing a sample for the determination of a pore characteristic of a porous substance with nuclear magnetic resonance spectroscopy are presented.

In 700, the method starts.

In 702, the porous substance is placed into an air-tight container 202.

In 704, a liquid-phase medium is inserted into the air-tight container 202, thus producing a confined portion 222 and a bulk portion 216 of the medium, the confined portion 222 being confined into the pores 214A, 214B of the porous substance and the bulk portion 216 surrounding at least a portion of the porous substance, the medium being selected to generate a magnetic environment for probe gas confined to the pores 214A, 214B that differs from the magnetic environment of the probe gas dissolved in the bulk portion 216.

In 706, a quantity of probe gas is dissolved into the medium, the probe gas being inert to the medium and to the porous substance and having a nuclear magnetic response to electromagnetic stimulation, the nuclear magnetic response depending on the magnetic environment of the probe gas, thus transferring at least a portion of the probe gas into the pores as dissolved in the confined portion 222.

In 708, the air-tight container 202 is sealed.

In 710, the method ends.

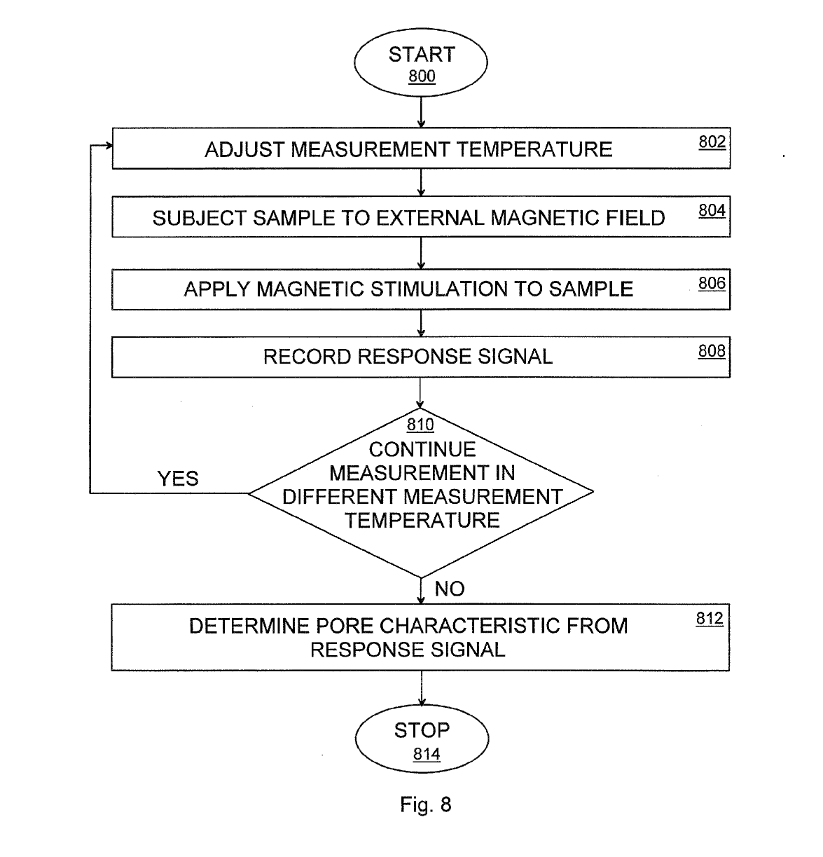

With reference to FIG. 8, embodiments of a method of determining a pore characteristic of a porous substance are presented.

In 800, the method starts.

In 802, the measurement temperature is adjusted.

In 804, a sample is subjected to an external magnetic field 128, the sample including the porous substance and a medium with a confined portion 222 confined into the pores of the porous substance and a bulk portion 216 surrounding at least a portion of the porous substance, the sample further including probe gas soluble to the medium and inert to the medium and to the porous substance and having a nuclear magnetic response to electromagnetic stimulation, the nuclear magnetic response depending on the magnetic environment of the probe gas, at least a portion of the probe gas being confined to the pores 214A, 214B and being transferred into the pores as dissolved in the confined portion 222, the medium being selected to generate a different magnetic environment for the probe gas confined to the pores 214A, 214B from the magnetic environment of the probe gas dissolved in the bulk portion 216.

In 806, electromagnetic stimulation is applied to the sample, the electromagnetic stimulation being selected to induce at least one response signal 122 in the probe gas. In an embodiment of the invention, the electromagnetic stimulation is selected to induce a first response signal 514 in the probe gas dissolved in the confined portion 402 and second response signal 516 in the probe gas dissolved in the bulk portion 404.

In 808, the at least one response signal is recorded. In an embodiment of the invention, the first response signal 514 and the second response signal 516 are recorded.

In 810, a decision is made whether or not to continue the NMR measurement at a different temperature. If the NMR measurement is continued, the measurement temperature is adjusted in 802.

If the NMR measurement is not continued, the pore characteristic is determined from the at least one response signal 122 in 812. In an embodiment of the invention, the pore characteristic is determined from the first response signal 514 and the second response signal 516.

In 814, the method ends.

Even though the invention is described above with reference to an example according to the accompanying drawings, it is clear that the invention is not restricted thereto but can be modified in several ways within the scope of the appended claims.

1. A method of determining a pore characteristic of a porous substance, characterized by
subjecting (804) a sample to an external magnetic field, the sample including the porous substance and a medium with a confined portion confined into the pores of the porous substance and a bulk portion surrounding at least a portion of the porous substance, the sample further including probe gas soluble to the medium and inert to the medium and to the porous substance and having a nuclear magnetic response to electromagnetic stimulation, the nuclear magnetic response depending on the magnetic environment of the probe gas, at least a portion of the probe gas being confined to the pores and being transferred into the pores as dissolved in the confined portion, the medium being selected to generate a magnetic environment for the probe gas confined to the pores that differs from the magnetic environment of the probe gas dissolved in the bulk portion;
applying (806) electromagnetic stimulation to the sample, the electromagnetic stimulation being selected to induce at least one response signal in the probe gas;
recording (808) the at least one response signal; and
determining (812) the pore characteristic from the at least one response signal.

2. The method of claim 1, characterized in that the medium is selected to have a lower phase-transition temperature in the confined portion than the phase-transition temperature in the bulk portion, the phase transition taking place from the liquid phase to the solid phase, the medium being further selected to have larger density in the solid phase than the density in the liquid phase, a sample temperature history including a first sample temperature and a second sample temperature following the first sample temperature, at which first sample temperature the confined portion and the bulk portion appear in the liquid state, and at which second sample temperature the confined portion and the bulk portion appear in the solid state, the method further including subjecting (804) the sample to the external magnetic field in the second sample temperature.

3. The method of claim 2, characterized by subjecting (804) the sample to the external magnetic field, applying (806) electromagnetic stimulation to the sample, and recording (808) the at least one response signal in a plurality of sample temperatures between the first sample temperature and the second sample temperature, thus producing a trend of response signals as a function of the sample temperature; and
determining (812) the pore characteristic from the trend of the response signals as a function of the sample temperature.

4. The method of claim 2, characterized in that the probe gas and the medium are selected to have higher solubility of the probe gas to the medium in the liquid state than the solubility of the probe gas to the medium in the solid state.

5. The method of claim 2, characterized by determining (812) at least one pore characteristic from the response signal, the pore characteristic being selected from a list comprising: pore size distribution, pore volume of the porous substance.

6. The method of claim 1, characterized in that the medium is condensed fluid, the medium being selected to provide a magnetic environment for the probe gas dissolved in the confined portion that differs from the magnetic environment for the probe gas dissolved in the bulk portion, and the method further including:
applying (806) electromagnetic stimulation to the sample, the electromagnetic stimulation being selected to induce a first response signal in the probe gas dissolved in the confined portion and second response signal in the probe gas dissolved in the bulk portion;
recording (808) the first response signal and the second response signal; and
determining (812) the pore characteristic from the first response signal and the second response signal.

7. The method of claim 6, characterized in that the medium is a liquid crystal and selected to have an isotropic phase in the confined portion and an anisotropic phase in the bulk portion in a measurement temperature.

8. The method of claim 6, characterized by determining (812) at least one pore characteristic from the first response signal and the second response signal, the pore characteristic being selected from a list comprising: pore size distribution, pore volume.

9. The method of claim 1, characterized in that the probe gas is ¹²⁹xenon.

10. The method of claim 1, characterized inthatthe medium is selected from a group comprising: acetonitrile, naphthalene.

11. A preparation method of preparing a sample for the determination of a pore characteristic of a porous substance with nuclear magnetic resonance spectroscopy, characterized by
placing (702) the porous substance into an air-tight container;
inserting (704) a liquid-phase medium into the air-tight container, thus producing a confined portion and a bulk portion of the medium, the confined portion being confined into the pores of the porous substance and the bulk portion surrounding at least a portion of the porous substance, the medium being selected to generate a magnetic environment for probe gas confined to the pores that differs from the magnetic environment of the probe gas dissolved in the bulk portion; and
dissolving (706) a quantity of probe gas into the medium, the probe gas being inert to the medium and to the porous substance and having a nuclear magnetic response to electromagnetic stimulation, the nuclear magnetic response depending on the magnetic environment of the probe gas, thus transferring at least a portion of the probe gas into the pores as dissolved in the confined portion.

12. The method of claim 11, characterized by inserting (704) the liquid-phase medium into the air-tight container, the medium being selected to have a lower phase-transition temperature in the confined portion than the phase-transition temperature in the bulk portion, the phase transition taking place from the liquid phase to the solid phase, the medium being further selected to have a larger density in the solid phase than the density in the liquid phase.

13. The method of claim 12, characterized in that the probe gas and the medium are selected to have a higher solubility of the probe gas to the medium in the liquid state than the solubility of the probe gas to the medium in the solid state.

14. The method of claim 11, characterized in that the medium is condensed fluid, the medium being selected to provide a magnetic environment for the probe gas dissolved in the confined portion that differs from the magnetic environment for the probe gas dissolved in the bulk portion, which thus results in that a response signal is generated in the probe gas dissolved in the confined portion that differs from a response signal being generated in the bulk portion when electromagnetic stimulation is applied to the sample.

15. The method of claim 14, characterized in that the medium is a liquid crystal and selected to have an isotropic phase in the confined portion and an anisotropic phase in the bulk portion in a measurement temperature.

16. A sample unit for determining a pore characteristic of a porous substance with nuclear magnetic resonance spectroscopy, including a porous substance, characterized in that the sample unit further includes:
a medium including a confined portion confined into the pores (214A, 214B) of the porous substance and a bulk portion surrounding at least a portion of the porous substance;
probe gas soluble to the medium and inert to the medium and to the porous substance and having a nuclear magnetic response to electromagnetic stimulation, the nuclear magnetic response depending on the magnetic environment of the probe gas, at least a portion of the probe gas being confined to the pores and being transferred into the pores as dissolved in the confined portion; and
the medium being selected to generate a magnetic environment for the probe gas confined to the pores that differs from the magnetic environment of the probe gas dissolved in the bulk portion.

17. The sample unit of claim 16, characterized in that the medium is selected to have a lower phase-transition temperature in the confined portion than the phase-transition temperature in the bulk portion, the phase transition taking place from the liquid phase to the solid phase, the medium being further selected to have larger density in the solid phase than the density in the liquid phase.

18. The sample unit of claim 17, characterized in that the sample unit has a sample temperature history including a first sample temperature and a second sample temperature following the first sample temperature, at which first sample temperature the confined portion and the bulk portion appear in the liquid state, and at which second sample temperature the confined portion and the bulk portion appear in the solid state; and
the sample temperature is the second sample temperature when determining the pore characteristic.

19. The sample unit of claim 17, characterized in that the probe gas and the medium are selected to have a higher solubility of the probe gas to the medium in the liquid state than the solubility of the probe gas to the medium in the solid state.

20. The sample unit of claim 16, characterized in that the medium is condensed fluid, the medium being selected to provide a magnetic environment for the probe gas dissolved in the confined portion that differs from the magnetic environment for the probe gas dissolved in the bulk portion, which thus results in that a different response signal is generated in the probe gas dissolved in the confined portion that differs from a response signal being generated in the bulk portion when electromagnetic stimulation is applied to the sample unit.

21. The sample unit of claim 20, characterized in that the medium is a liquid crystal and selected to have an isotropic phase in the confined portion and an anisotropic phase in the bulk portion in a measurement temperature.
